(19) United States
(12) Patent Application Publication
(10) Pub. No.: US 2018/0263390 A1
(43) Pub. Date: Sep. 20, 2018

(54) TABLEWARE WITH POLYMER GRIP AND MANUFACTURING METHOD THEREOF

(71) Applicant: Kennex (Hong Kong) Limited, Hong Kong (CN)

(72) Inventor: Kwong Ming Lam, Hong Kong (CN)

(73) Assignee: Kennex (Hong Kong) Limited, Hong Kong (CN)

(21) Appl. No.: 15/460,907

(22) Filed: Mar. 16, 2017

(51) Int. Cl. A47G 19/02; C09D 201/00

(52) U.S. Cl. CPC A47G 19/02; C09D 201/00

(57) ABSTRACT

The present invention relates to tableware, such as dishes, or glassware (i.e., cups, glasses, saucers, plates, bowls), having a polymer grip provided underneath, which prevents sliding of the tableware on tables, or other flat or smooth surfaces.

The present invention relates to tableware, such as cups, glasses, saucers, plates, and other crockery, having a polymer grip underneath, which prevents the tableware from sliding when placed on tables or surfaces, and a manufacturing method thereof.

### BACKGROUND OF THE INVENTION

### 1. Field of the Invention

The present invention relates to tableware, such as cups, glasses, saucers, plates, bowls, or other crockery, having a polymer grip provided underneath, which prevents the tableware or from sliding on tables or surfaces, and a manufacturing method thereof.

### 2. Description of the Related Art

Tableware presently has smooth undersides which make the tableware susceptible to sliding on tables and flat, smooth surfaces, causing them to fall off those tables or surfaces, producing breakage. Over time, breakage costs can accrue, and in particularly high usage fields, such as restaurant use, the costs may become prohibitive. Further, in order to keep down costs, tableware and crockery of lower quality can be used, which causes even more breakage, and may not meet the aesthetics required (i.e., for a higher end restaurant).

Although coasters and mats are used in order to ameliorate this issue, they are not always of high quality, nor are they always pertinent to the usage of the tableware, nor add to the aesthetics thereof, and may also add to the costs of the table settings.

Accordingly, a method and apparatus to reduce breakage of tableware is desired, which will not decrease the aesthetics thereof, which does not interfere with the usage of the tableware, and which does not add substantive additional cost.

### SUMMARY OF THE INVENTION

The present invention relates to tableware, such as dishes, or glassware (i.e., cups, glasses, saucers, plates, bowls), having a polymer grip provided underneath, which prevents sliding of the tableware on tables, or other flat or smooth surfaces.

In one embodiment, the grip for tableware includes: a polymer coating applied to a surface of an item of tableware; wherein the polymer coating is applied to at least a portion of the surface of the item, the portion which interfaces with one of a table, flat, or smooth surface.

In one embodiment, the polymer is applied using a polymer injection mechanism.

In one embodiment, the polymer is clear, but may be of any color.

In one embodiment, the polymer is applied in sufficient quantity, and to particular portions, to form a grip which holds the tableware item to a table or flat or smooth surface, without affecting the stability of the item of tableware.

In one embodiment, the polymer provides sufficient flexibility and strength, to cushion the tableware item on the table or surface, yet is not easily removed in daily use.

In one embodiment, the polymer coating is not removed or deformed when subjected to microwaves from a microwave oven.

Thus, the grip of the present invention prevents tableware from slipping from tables, flat, or smooth surfaces, and does not add substantial cost thereto.

Although the present invention is directed to tableware, one of ordinary skill in the art would know that the polymer coating can be applied to virtually any item where cushioning and anti-slip qualities are desired.

Thus has been outlined, some features consistent with the present invention in order that the detailed description thereof that follows may be better understood, and in order that the present contribution to the art may be better appreciated. There are, of course, additional features consistent with the present invention that will be described below and which will form the subject matter of the claims appended hereto.

In this respect, before explaining at least one embodiment consistent with the present invention in detail, it is to be understood that the invention is not limited in its application to the details of construction and to the arrangements of the components set forth in the following description or illustrated in the drawings. Methods and apparatuses consistent with the present invention are capable of other embodiments and of being practiced and carried out in various ways. Also, it is to be understood that the phraseology and terminology employed herein, as well as the abstract included below, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the methods and apparatuses consistent with the present invention.

### BRIEF DESCRIPTION OF THE DRAWINGS

FIG. 1 is a schematic drawing in perspective view, of a polymer injection machine as it ejects polymer on the underside of an item of tableware, according to one embodiment consistent with the present invention.

FIGS. 2A and 2B show an item of tableware in plan view (showing the underside thereof) and side view, respectively, with a polymer grip applied, according to one embodiment consistent with the present invention.

### DESCRIPTION OF THE INVENTION

The present invention relates to tableware, such as dishes, or glassware (i.e., cups, glasses, saucers, plates, bowls), having a polymer grip provided underneath, which prevents sliding of the tableware on tables, or other flat or smooth surfaces.

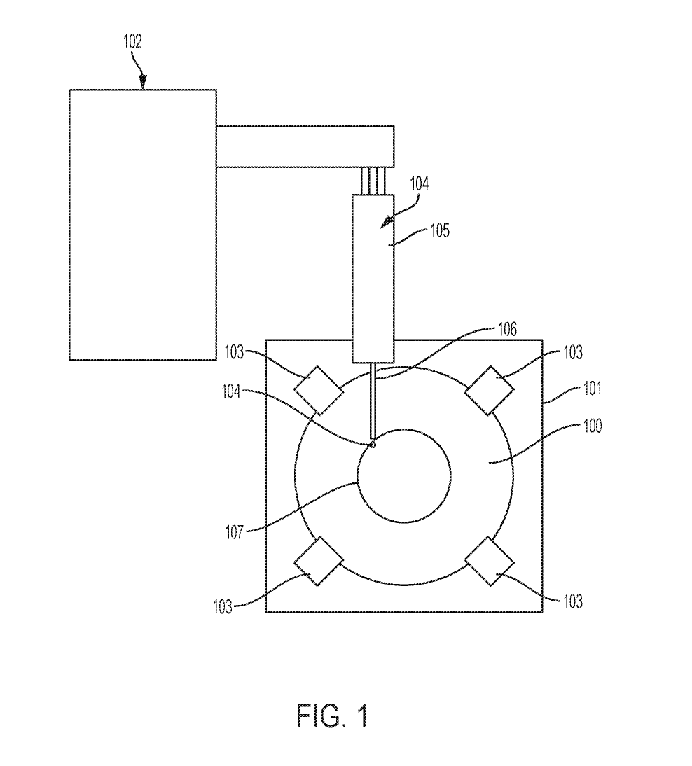

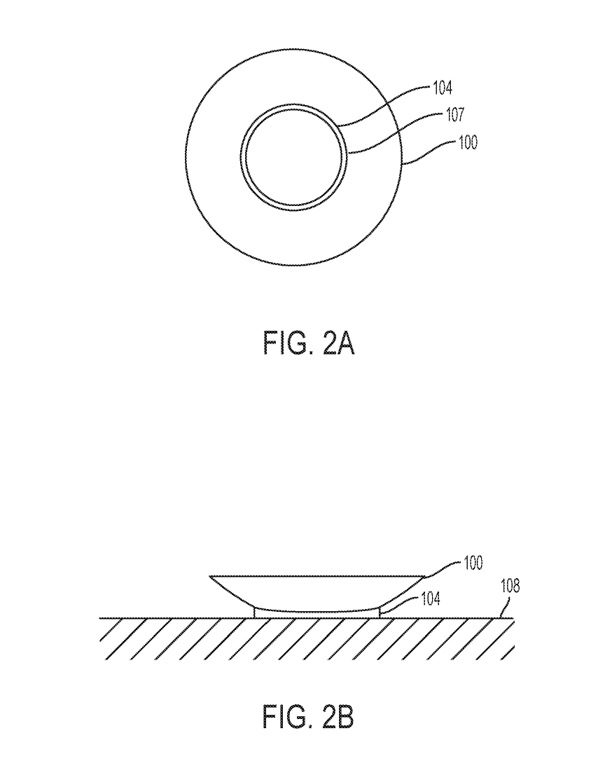

In one embodiment as shown in FIG. 1, an item of tableware 100 (such as a plate, saucer, etc.) is placed in a holder 101 beneath a polymer injection mechanism 102. The item 100 is placed faced down and cushioned and secured against impact using tabs 103 that would lead to chipping or breakage of the tableware. Once secured, the polymer injection machine 102, which has been prefilled with a polymer 104 in its injection mechanism 105, such as silicon, synthetic rubber, etc., which has the advantage of providing a grip to the tableware, is started. The polymer 104 is ejected from the injection needle 106 of polymer injection machine 102, and a coating of polymer 104 is applied to the item of tableware 100 at a predetermined position (i.e., rim 107) (see FIG. 2A).

In one embodiment, the polymer injection machine 102 is pre-programmed with the dimensions of the tableware item 100, so that it is able to reproduce the polymer application quickly, efficiently, and in large numbers in a sequential manner.

In one embodiment, the polymer 104 being applied is in clear form, so that it is does not interfere with the aesthetics of the tableware, and is unnoticed by the user. However, it is possible that a colored form would be preferred.

In one embodiment, the polymer 104 should be applied in sufficient quantity to the tableware item 100, such that it is able to form a grip which holds the tableware item 100 to a table or flat or smooth surface, without affecting the stability of the item of tableware 100.

In one embodiment, in order to provide stability and coverage of the tableware item 100, the polymer 104 is applied by the polymer injection machine 102, at least to portions or positions where the tableware interfaces with the table or surface 108, such as, for example, the circular rims 107 under dishes, circular rims under cups, or circular edges of glassware (see FIGS. 2A-2B). However, the polymer 104 may be applied at any position on the tableware item 100 where it would provide the requisite coverage or stability to the tableware item 100.

In on embodiment, the polymer 104 is chosen such that it provides sufficient flexibility and strength, to cushion the tableware item 100 on the table or surface, yet is not easily removed in daily use.

In one embodiment, once the polymer 104 is applied, it is left to cure at room temperature upside down (see FIG. 2A), and then the item 100 is ready for use. Once ready for use, the item 100 is placed on the table or surface 108, and the polymer grip 104 cushions and provides non-slip treatment to the tableware item 100 (see FIG. 2B).

In one embodiment, the polymer 104 is sufficiently stable such that the power and/or heat applied when the item 100 is placed in a microwave oven, does not allow the polymer 104 to deform, or be removed from the item 100.

Accordingly, the present invention provides a method and apparatus to reduce breakage of tableware, which will be of minimal aesthetics impact to a user, is in sufficient coverage to provide stability and cushioning to the items of tableware, and which does not interfere with the usage thereof. Thus, the present invention provides a needed method and apparatus which prevents tableware from slipping from tables, flat, or smooth surfaces, and which does not add substantial cost thereto.

Finally, although the present invention is directed to tableware, one of ordinary skill in the art would know that the polymer coating can be applied to virtually any item where cushioning and anti-slip qualities are desired.

It should be emphasized that the above-described embodiments of the invention are merely possible examples of implementations set forth for a clear understanding of the principles of the invention. Variations and modifications may be made to the above-described embodiments of the invention without departing from the spirit and principles of the invention. All such modifications and variations are intended to be included herein within the scope of the invention and protected by the following claims.

What is claimed is:

1. A grip for tableware comprising:
a polymer coating applied to a surface of an item of tableware;
wherein said polymer coating is applied to at least a portion of said surface of said item, said portion which interfaces with one of a table, flat, or smooth surface.

2. The grip of claim 1, wherein said polymer is applied using a polymer injection mechanism.

3. The grip of claim 1, wherein said polymer coating is not removed or deformed when subjected to microwaves from a microwave oven.
